(19) United States
(12) Patent Application Publication
(10) Pub. No.: US 2007/0069625 A1
(43) Pub. Date: Mar. 29, 2007

(54) Fluorescent lamp with long lifetime, backlight assembly having the same and display device having the same

(75) Inventors: Jin-Sung Choi, Choongcheongnam-do (KR); Sang-Hyuck Yoon, Seoul (KR); Jheen-Hyeok Park, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/491,366

(22) Filed: Jul. 21, 2006

(30) Foreign Application Priority Data
Jul. 22, 2005 (KR) 2005-66940

(51) Int. Cl. H01J 1/62

(52) U.S. Cl. 313/491

(57) ABSTRACT

A fluorescent lamp with a lengthened lifetime that emits a reduced amount of ultraviolet light is presented. The lamp includes a discharge tube, a plurality of discharge electrodes and a discharge gas. The discharge tube is made of a material containing titanium oxide, and a fluorescent layer is deposited on an inner surface of the discharge tube. The discharge electrodes are made of a material containing a nickel-niobium alloy. The discharge electrodes are on end portions of the discharge tube, respectively. The discharge gas is in the discharge tube. A backlight assembly and a display device made with such fluorescent lamp is also presented.

### CROSS-REFERENCE TO RELATED APPLICATION

The present application claims priority from Korean Patent Application No. 2005-66940 filed on Jul. 22, 2005, the disclosure of which is hereby incorporated herein by reference in its entirety.

### BACKGROUND OF THE INVENTION

1. Field of the Invention

The present invention relates to a fluorescent lamp, a backlight assembly having the fluorescent lamp and a display device having the fluorescent lamp. More particularly, the present invention relates to a fluorescent lamp with increasing lifetime that can block ultraviolet light, a backlight assembly having the fluorescent lamp, and a display device having the fluorescent lamp.

2. Description of the Related Art

A display device, in general, receives an electric signal that is processed by an information processing device and displays an image according to the electric signal. A liquid crystal display (LCD) device, which is a widely used type of display device, displays images using electrical and optical characteristics of liquid crystals.

An LCD device includes an LCD panel and a light generating unit. The LCD panel displays an image using the light generated from the light generating unit.

The light generating unit may use a cold cathode fluorescent lamp (CCFL), an external electrode fluorescent lamp (EEFL), or a light emitting diode (LED) as the light source, among other possibilities. Of these light sources, CCFL has been especially widely used as the light source. A CCFL includes a glass tube, a fluorescent layer and electrodes. The glass tube contains a discharge gas, e.g. mercury gas. The fluorescent layer is coated on the glass tube, and the electrodes are at the end portions of the glass tube. When a voltage difference is applied to the electrodes, electrons are generated in one of the electrodes. The electrons impact the molecules of the discharge gas and generate ultraviolet light. The fluorescent layer converts the ultraviolet light into visible light.

Metal molecules of the electrodes are discharged through sputtering, and the metal molecules are combined with mercury molecules of the mercury gas to form a mercury amalgam on the glass tube. This phenomenon decreases the number of electrons and the amount of the mercury gas, shortening the lifetime of the CCFL. That is, the amount of metal in the electrodes is decreased through the sputtering to decrease the lifetime of the CCFL.

In addition, a portion of the ultraviolet light passes through the glass tube and the fluorescent layer to cause a deterioration of optical elements such as a diffusion plate, optical sheets, etc. over time. As a result, the quality of the displayed image becomes compromised.

### SUMMARY OF THE INVENTION

The present invention provides a fluorescent lamp with a lengthened lifetime that is capable of blocking ultraviolet light. The backlight assembly also provides a backlight assembly having the above-mentioned fluorescent lamp. The present invention still also provides a display device having the above-mentioned fluorescent lamp.

According to one aspect, the invention is a fluorescent lamp that includes a discharge tube, a plurality of discharge electrodes and a discharge gas. The discharge tube is made of a material containing titanium oxide, and the fluorescent layer is deposited on an inner surface of the discharge tube. The discharge electrodes are made of a material containing a nickel-niobium alloy and coupled to end portions of the discharge tube. The discharge gas is in the discharge tube.

According to another aspect, the invention is a display device that includes the above-described fluorescent lamp, a display panel and an optical member. The display panel is optically coupled to the fluorescent lamp to display an image using a light generated from the fluorescent lamp. The optical member is interposed between the fluorescent lamp and the display panel.

In yet another aspect, the invention is a backlight assembly including the above-described fluorescent lamp. The backlight assembly includes a plurality of the lamps, at least one of which is the above-described fluorescent lamp. The plurality of lamps are sandwiched between an optical member and a reflecting plate. The optical member improves the optical characteristics of light generated by the fluorescent lamps, and the reflecting plate reflects light from the fluorescent lamps toward the optical plate. The backlight assembly has a receiving container that receives the lamps, the optical member, and the reflecting plate.

According to the present invention, the electrode includes the nickel-niobium alloy to increase a lifetime of the lamp. In addition, the glass tube includes titanium oxide to block the ultraviolet, thereby improving an image display quality of the display device.

### BRIEF DESCRIPTION OF THE DRAWINGS

The above and other advantages of the present invention will become more apparent by describing in detail exemplary embodiments thereof with reference to the accompanying drawings, in which:

FIG. 1 is a cross-sectional view showing a fluorescent lamp in accordance with one embodiment of the present invention;

FIG. 2 is an exploded perspective view showing a backlight assembly in accordance with one embodiment of the present invention;

FIG. 3 is a cross-sectional view showing the backlight assembly shown in FIG. 2; and

FIG. 4 is an exploded perspective view showing a display device in accordance with one embodiment of the present invention.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-sectional illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes or regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

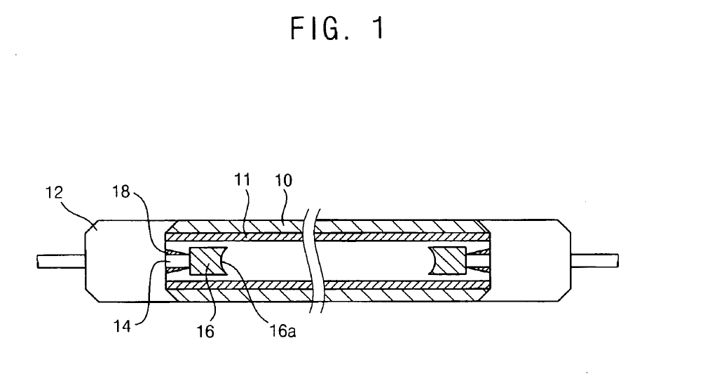

FIG. 1 is a cross-sectional view showing a fluorescent lamp in accordance with one embodiment of the present invention. In FIG. 1, the fluorescent lamp includes a cold cathode fluorescent lamp (CCFL).

Referring to FIG. 1, the CCFL includes a glass tube 10, a sealing part 12, a lead line 14, an electrode 16 and a cover 18. Alternatively, the CCFL may include a plurality of sealing parts, a plurality of lead lines, a plurality of electrodes and a plurality of covers. The glass tube 10 includes an internal space to receive a gas mixture that includes mercury, argon, neon, etc. The sealing part 12 is on an end portion of the glass tube 10 to seal the mixture gas in the internal space. The lead line 14 extends toward the internal space of the glass tube 10 through the sealing part 12. The cover 18 is on the sealing part 12 to cover the electrode 16. A fluorescent layer 11 is coated on the glass tube 10. In FIG. 1, a discharge surface 16a of the electrode 16 has a concave shape. The discharge surface 16a of the electrode 16 is in the internal space of the CCFL. In some embodiments, the discharge surface 16a of the electrode 16 may have a flat shape, an embossed shape, etc. The fluorescent layer 11 includes a fluorescent material such as a rare earth element. Examples of the rare earth element that can be used for the fluorescent layer 11 include yttrium, cerium, terbium, etc. In FIG. 1, the mixture gas includes a neon gas and an argon gas. The volumic proportion of the neon gas is about 80% to about 90%. The pressure of the mixture gas is about 55 Torr to about 60 Torr.

In FIG. 1, the glass tube 10 includes titanium dioxide (TiO₂). When the glass tube 10 includes titanium dioxide, the color of the glass tube 10 takes on a yellowish hue and the glass tube 10 blocks ultraviolet light. For example, the glass tube 10 includes about 5 percents by weight to about 20 percents by weight of titanium dioxide.

The electrode 16 includes a nickel-niobium alloy. Alternatively, the electrode 16 may be made of a nickel-niobium composition. For example, the electrode 16 includes about 6% to about 32% niobium. The nickel-niobium alloy has a greater sputter-resistance than pure nickel and thus lengthens the lifetime of the electrode 16. When the nickel-niobium alloy has a niobium content of less than about 6%, the electrode 16 has substantially the same sputter-resistance as a pure nickel electrode. When the nickel-niobium alloy includes more than about 32% niobium, the hardness of the electrode 16 is greatly increased so that the electrode 16 may not be easily molded. For example, the electrode 16 may include Ni₃Nb. Alternatively, solid Ni₃Nb may be on a surface of the electrode 16.

When the electrode 16 includes about 6% to about 32% niobium, the electrode 16 is easily molded, and may also be easily soldered with the lead line 14. In addition, the electrode 16 may not be oxidized at a high temperature.

Table I represents the relationship between the weight percent of niobium and sputtering ratio. Electrodes having various weight percents of niobium are sputtered, and sputtering amounts of the sputtered electrodes are measured to determine sputtering ratios of the electrodes.

To obtain the results of Table I, an accelerating voltage, a decelerating current and a decelerating voltage about 500 V, about 210 mA and about 250 V, respectively, were applied to the electrons. An argon ion beam irradiated each of the electrodes at an incident angle of about 45° for about sixty minutes. A pressure of an argon gas is about 2×10⁻⁶ Torr. The depth of a hole formed by the argon ion beam was measured to determine each of the sputtering ratios per minute with reference to a pure nickel.

TABLE I
Effect of Niobium Content on Sputtering Ratio

| | Composition | | Sputtering ratio |
|---|---|---|---|
| Electrode Number | (percent by weight of niobium) | | (%) |
| 1 | 0 | (Pure Ni) | 100 |
| 2 | 100 | (Pure Nb) | 50 |

| | | |
|---|---|---|
| 3 | 2 | 94 |
| 4 | 5 | 92 |
| 5 | 6 | 71 |
| 6 | 8 | 62 |
| 7 | 10 | 60 |
| 8 | 15 | 59 |
| 9 | 20 | 58 |
| 10 | 23.2 | 54 |
| 11 | 28 | 53 |
| 12 | 32 | 52.5 |
| 13 | 35 | 52 |

In the third, fourth and fifth electrodes, where each of the third, fourth and fifth electrodes contains less than about 6% niobium, the sputtering ratio decreased dramatically as the content of niobium increased. In the twelfth and thirteenth electrodes, where each of the twelfth and thirteenth electrodes includes more than about 32% niobium, the sputtering ratio remained substantially same even though niobirum content was increased so that niobium is saturated in the nickel-niobium alloy.

Table I indicates that when the electrode includes more than about 32% niobium, the sputtering ratio does not further increase with extra niobium content.

The procedure used to produce the results of Table I is not a limitation of the invention and may be adapted as deemed fit. For example, although each electrode was irradiated with an argon beam for about sixty minutes in this example, the irradiation period may be shortened to about thirty minutes in some cases.

Table II represents the relationship between the weight percent of the niobium and hardness. The hardness of the electrode increased with the weight percent of the niobium. When the weight percent of niobium is about 35%, the Vickers to hardness is about 430 to about 470. At this hardness level, it becomes difficult to mold the electrode using a press. Generally, it is difficult to mold the electrode with a press when the Vickers hardness of the electrode is more than about 400. When the Vickers hardness of the electrode is no more than about 230, the electrode is still easily moldable using the press.

In table I, the sputter-resistance of the electrode dramatically increased as niobium content was increased to about 6%. Above weight content of about 6%, the increase in sputter resistance was more gradual. When the weight percent of niobium is more than about 32%, the sputter-resistance of the electrode seemed to remain substantially constant and the hardness of the electrode increased. With a higher hardness, it becomes more difficult to mold the electrode.

In the embodiment of FIG. 1, the weight percent of niobium is between about 6% to about 35% so that the sputtering ratio of the electrode is increased and the electrode may be molded using the press. For example, the weight percent of niobium may be about 6% to about 15%. Preferably, the weight percent of niobium is about 6% to about 10%.

TABLE II
Effect of Niobium Content on Hardness

| | Composition | | Hardness |
|---|---|---|---|
| Number of Electrode | (percent by weight of niobium) | | (Hv) |
| 1 | 0 | (Pure Ni) | — |
| 2 | 100 | (Pure Nb) | — |

| | | |
|---|---|---|
| 3 | 2 | 110-130 |
| 4 | 5 | 140-160 |
| 5 | 6 | 150-170 |
| 6 | 8 | 160-180 |
| 7 | 10 | 180-200 |
| 8 | 15 | 210-230 |
| 9 | 20 | 250-270 |
| 10 | 23.2 | 350-370 |
| 11 | 28 | 360-380 |
| 12 | 32 | 400-430 |
| 13 | 35 | 430-470 |

Table III represents a relationship between the luminance of the fluorescent lamp and the operation period of the fluorescent lamp. The luminance measurements are made with respect to the initial luminance (e.g., luminance at first operation).

| Electrode Composition | Luminance at 100 hr | Luminance at 500 hr |
|---|---|---|
| Pure Ni electrode | 97.4% | 94.3% |
| Ni—Nb alloy electrode & | 97.2% | 94.5% |
| TiO₂ glass tube | | |

The fluorescent lamp including the electrode made of the nickel-niobium alloy and the glass tube containing TiO₂ has substantially similar luminance level as the fluorescent lamp including the electrode having the pure nickel both after 100 hours of operation and 500 hours of operation. However, as discussed above, the electrode having the nickel-niobium alloy has a greater sputter-resistance than the electrode having the pure nickel.

Table IV represents a relationship between color coordinates of the light generated from the fluorescent lamp and the period of operation for the fluorescent lamp.

| | Deviation of Color | Deviation of Color |
|---|---|---|
| Electrode | Coordinates (Wx/Wy) | Coordinates (Wx/Wy) |
| Composition | at 100 hr of operation | at 500 hr of operation |
| Pure Ni electrode | +0.0008/+0.0019 | +0.0014/+0.0026 |
| Ni—Nb alloy | +0.0007/+0.0017 | +0.0014/+0.0022 |
| electrode & TiO₂ | | |
| glass tube | | |

The glass tube includes TiO₂ so that the glass tube blocks the ultraviolet light. The glass tube including TiO₂ protects the optical elements and reduces the deviation of color coordinates.

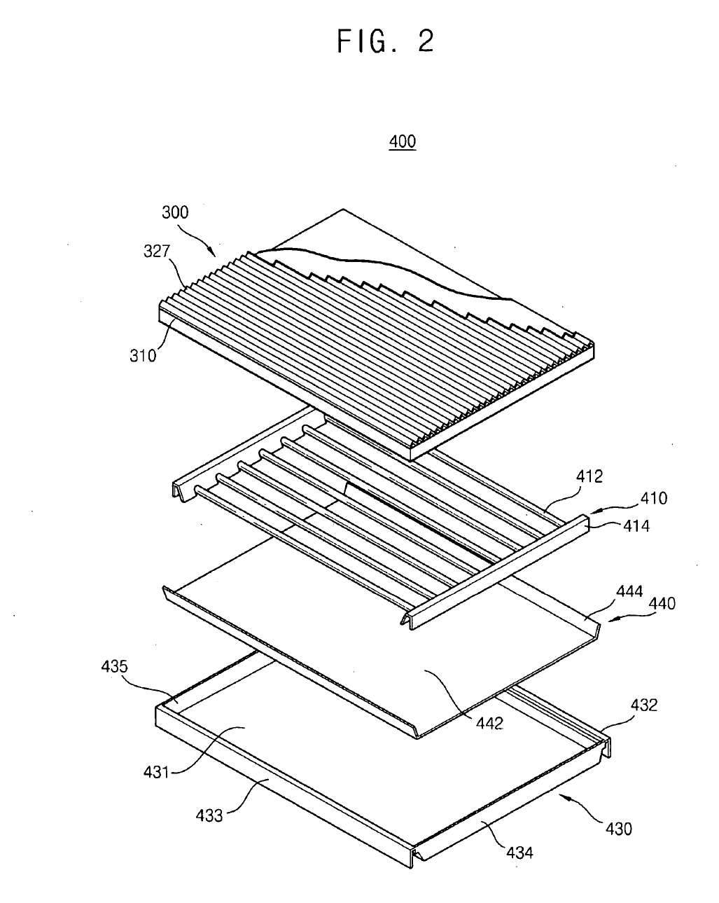

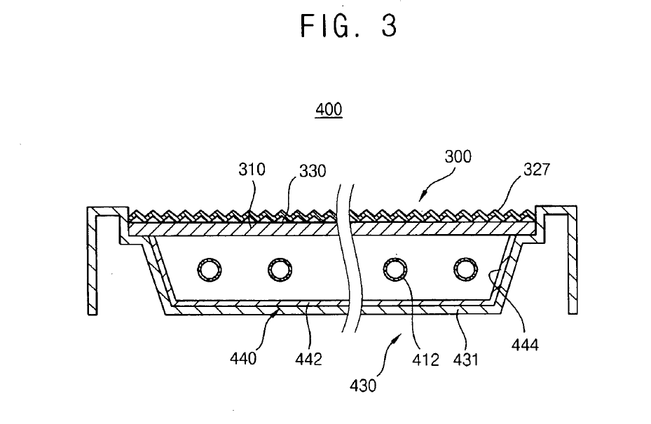

FIG. 2 is an exploded perspective view showing a backlight assembly in accordance with one embodiment of the present invention. FIG. 3 is a cross-sectional view showing the backlight assembly of FIG. 2.

Referring to FIGS. 2 and 3, the backlight assembly 400 includes a lamp assembly 410, an optical member 300, a receiving container 430 and a reflecting plate 440. The lamp assembly 410 generates light. The optical member 300 improves optical characteristics of the light generated from the lamp assembly 410. For example, the optical member 300 increases luminance uniformity and guides the light toward the front of the display panel. The receiving container 430 receives the lamp assembly 410 and the optical member 300. The reflecting plate 440 is interposed between the lamp assembly 410 and the receiving container 430.

In particular, the lamp assembly 410 includes a plurality of lamps 412 and a lamp fixing member 414. For example, the lamp assembly 410 may further include two lamp fixing members 414 on both sides of the lamps 412. The lamp fixing member 414 fixes the lamps to the receiving container 430. The lamps of FIGS. 2 and 3 are same as in FIG. 1. Thus, the same reference numerals will be used to refer to the same or like parts as those described in FIG. 1 and any redundant explanation concerning the above elements will be omitted.

The lamp fixing member 414 receives an electric power applying member (not shown). The electric power applying member (not shown) applies an externally provided driving voltage to the lamps 412 that are arranged substantially parallel to each other.

The receiving container 430 includes a bottom plate 431 and four sidewalls 432, 433, 434 and 435 that protrude from the bottom plate 431. The receiving container 430 receives the lamp assembly 410 and the optical member 300. The lamp assembly 410 is on the bottom plate 431 of the receiving container 430. The optical member 300 is on the lamp assembly 410.

The optical member 300 diffuses the light generated from the lamp 412, and increases the luminance of the primary display surface. The optical member 300 includes an optical substrate 310, a brightness enhancement pattern 327 on the optical substrate 310 and an air layer 330 interposed between the optical substrate 310 and the brightness enhancement pattern 327.

The reflecting plate 440 includes a flat portion 442 and a bent portion 444 that is connected to a side of the flat portion 442. A portion of the light generated from the lamps 412 is reflected from the reflecting plate 440 toward the optical member 300.

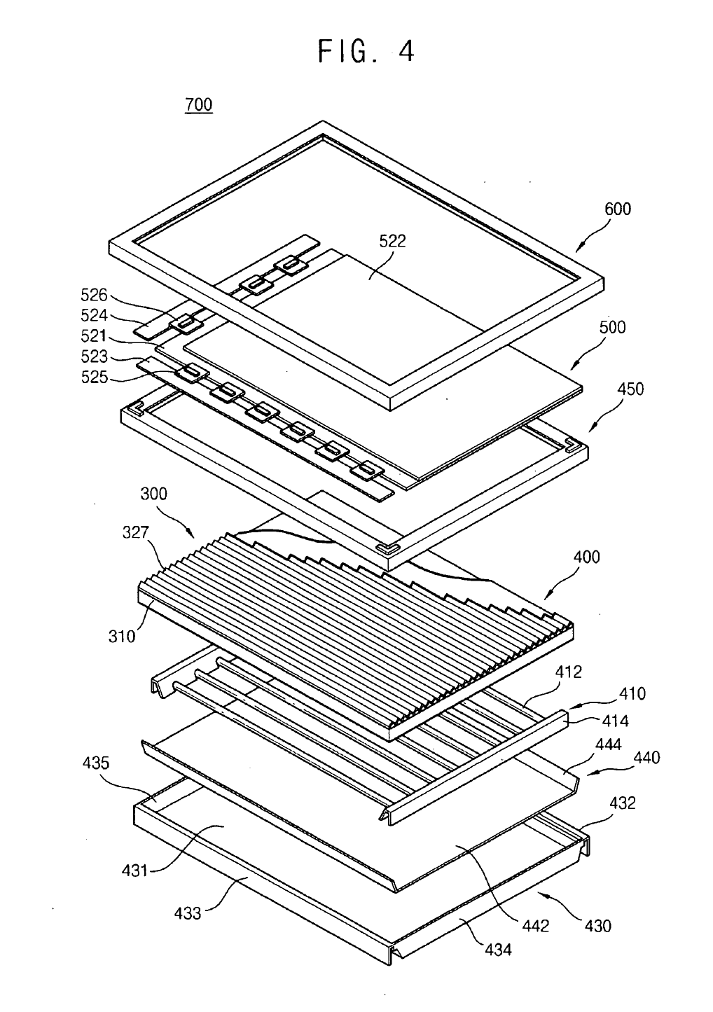

FIG. 4 is an exploded perspective view showing a display device in accordance with one embodiment of the present invention.

Referring to FIG. 4, the display device 700 includes the backlight assembly 400, a display panel 500 and a top chassis 600.

As described above, the backlight assembly 400 includes the lamp assembly 410, the optical member 300, the receiving container 430 and the reflecting plate 440. The lamp assembly 410 includes a plurality of lamps 412 arranged substantially parallel to each other to generate a light. The optical member 300 improves optical characteristics of the light generated from the lamp assembly 410. The receiving container 430 receives the lamp assembly 410 and the optical member 300. The reflecting plate 440 is interposed between the lamp assembly 410 and the receiving container 430. The receiving container 430 is combined with the display panel 500 through a middle chassis 450.

The display panel 500 includes a thin film transistor (TFT) substrate 521, a color filter substrate 522, a data printed circuit board 523 and a gate printed circuit board 524.

The data printed circuit board 523 is connected to the display panel 500 through a data tape carrier package 525. The gate printed circuit board 524 is connected to the display panel 500 through a gate tape carrier package 526.

The TFT substrate 521 corresponds to the color filter substrate 522. A liquid crystal layer (not shown) is interposed between the TFT substrate 521 and the color filter substrate 522. Liquid crystals of the liquid crystal layer (not shown) vary their arrangement in response to an electric field applied thereto, and light luminance of the liquid crystal layer (not shown) is changed, thereby displaying an image.

The top chassis 600 fixes the display panel 500, which is fixed to the middle chassis 450, to the receiving container 430 to protect the display panel 500 in case of an external impact.

According to the present invention, the electrode includes the nickel-niobium alloy to increase a lifetime of the lamp. In addition, the glass tube includes titanium oxide to block the ultraviolet, thereby improving an image display quality of the display device.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A fluorescent lamp comprising:
a discharge tube made of a material containing titanium oxide;
a fluorescent layer deposited on an inner surface of the discharge tube;
a plurality of discharge electrodes made of a material containing a nickel-niobium alloy, the discharge electrodes being coupled to end portions of the discharge tube; and
a discharge gas in the discharge tube.

2. The fluorescent lamp of claim 1, wherein the nickel-niobium alloy comprises about 6 percent by weight to about 32 percent by weight of niobium.

3. The fluorescent lamp of claim 1, wherein the nickel-niobium alloy comprises about 6 percent by weight to about 10 percent by weight of niobium.

4. The fluorescent lamp of claim 3, wherein the discharge gas comprises a mixture of neon and argon, and the mixture comprises about 80 percent to 90 percent by volume of neon.

5. The fluorescent lamp of claim 4, wherein a pressure of the discharge gas is about 55 Torr to about 60 Torr.

6. The fluorescent lamp of claim 5, wherein the discharge tube comprises about 5 percent by weight to about 20 percent by weight of titanium oxide.

7. The fluorescent lamp of claim 1, wherein a Vickers hardness of the nickel-niobium alloy is no more than about 400.

8. The fluorescent lamp of claim 1, wherein Ni₃Nb is on a surface of each of the discharge electrodes.

9. The fluorescent lamp of claim 1, wherein a discharge surface of each of the discharge electrodes has a concave shape.

10. A display device comprising:
a fluorescent lamp including:
a discharge tube made of a material containing titanium oxide;
a fluorescent layer deposited on an inner surface of the discharge tube;
a plurality of discharge electrodes made of a material containing a nickel-niobium alloy, the discharge electrodes being coupled to end portions of the discharge tube; and
a discharge gas in the discharge tube;
a display panel optically coupled to the fluorescent lamp to display an image using light generated from the fluorescent lamp; and
an optical member interposed between the fluorescent lamp and the display panel.

11. The display device of claim 10, wherein the nickel-niobium alloy comprises about 6 percent by weight to about 32 percent by weight of niobium.

12. The display device of claim 10, wherein the nickel-niobium alloy comprises about 6 percent by weight to about 10 percent by weight of niobium.

13. The display device of claim 12, wherein the discharge gas comprises a mixture of neon and argon, and the mixture comprises about 80 percent by volume to about 90 percent by volume of neon.

14. The display device of claim 13, wherein a pressure of the discharge gas is about 55 Torr to about 60 Torr.

15. The display device of claim 14, wherein the discharge tube comprises about 5 percent by weight to about 20 percent by weight of titanium oxide.

16. The display device of claim 10, wherein a discharge surface of each of the discharge electrodes has a concave shape.

17. The display device of claim 10, wherein the display panel comprises a thin film transistor substrate, a color filter substrate and a liquid crystal layer interposed between the thin film transistor substrate and the color filter substrate.

18. The display device of claim 10, wherein a Vickers hardness of the nickel-niobium alloy is no more than about 400.

19. The display device of claim 10, wherein Ni₃Nb is on a surface of each of the discharge electrodes.

20. The display device of claim 10, further comprising a plurality of fluorescent lamps aligned substantially parallel to each other.

21. A backlight assembly comprising:
a plurality of lamps, at least one of the lamps including:
a discharge tube made of a material containing titanium oxide;
a fluorescent layer deposited on an inner surface of the discharge tube;
a plurality of discharge electrodes made of a material containing a nickel-niobium alloy, the discharge electrodes being coupled to end portions of the discharge tube; and
a discharge gas in the discharge tube;
an optical member and a reflecting plate sandwiching the plurality of fluorescent lamps, the optical member improving optical characteristics of light generated by the fluorescent lamps and the reflecting plate reflecting light from the fluorescent lamps toward the optical plate; and
a receiving container for receiving the lamps, the optical member, and the reflecting plate.
